(19) United States
(12) Patent Application Publication
(10) Pub. No.: US 2024/0318026 A1
(43) Pub. Date: Sep. 26, 2024

(54) COATING COMPOSITION COMPRISING A FLUOROPOLYMER AND A FLUORINATED ALCOHOL IN A FLUORINATED SOLVENT SUITABLE FOR ELECTRONIC COMMUNICATION ARTICLES

(71) Applicant: 3M INNOVATIVE PROPERTIES COMPANY, St. Paul, MN (US)

(72) Inventors: Zai-Ming Qiu, Woodbury, MN (US); Naiyong Jing, St. Paul, MN (US)

(21) Appl. No.: 18/579,618

(22) PCT Filed: Aug. 12, 2022
(86) PCT No.: PCT/IB2022/057556

§ 371 Date: Jan. 16, 2024

Related U.S. Application Data
(60) Provisional application No. 63/244,803, filed on Sep. 16, 2021.

(51) Int. Cl. C09D 127/18; C08K 5/05; C08K 5/544; C09D 7/20; C09D 7/63

(52) U.S. Cl. CPC C09D 127/18; C08K 5/05; C08K 5/544; C09D 7/20; C09D 7/63

(57) ABSTRACT

Coating compositions are described comprising a fluoropolymer; a fluorinated solvent; and a fluorinated alcohol. In some embodiments, the coating composition further comprises a compound with one or more alkoxy silane groups and/or a compound with one or more amine groups. When such compound is a crosslinking compound, the fluoropolymer typically comprises cure sites. The coating composition may further comprise fillers such as silica, glass fibre, (e.g. crystalline) fluoropolymer particles, and combination thereof. Also described are methods of coating a substrate and articles, such as telecommunication articles.

### SUMMARY

In one embodiment, a coating composition is described comprising a fluoropolymer; a fluorinated solvent; and a fluorinated alcohol. In some embodiments, the fluoropolymer is soluble in the fluorinated solvent. The fluoropolymer may comprise at least 80, 85, or 90 wt. % of polymerized units of perfluorinated monomers selected from tetrafluoroethene (TFE) and one or more unsaturated perfluorinated alkyl ethers. In some embodiments, the fluoropolymer is insoluble in the fluorinated alcohol. The fluorinated alcohol is typically present in an amount no greater than 10 wt. % of the sum of the fluorinated solvent and fluorinated alcohol. The fluorinated solvent can be a partially fluorinated ether such as 3-ethoxy perfluorinated 2-methyl hexane or 3-methoxy perfluorinated 4-methyl pentane. In some embodiments, the coating composition further comprises a compound with one or more alkoxy silane groups and/or a compound with one or more amine groups. When such compound is a crosslinking compound, the fluoropolymer typically comprises cure sites. In some embodiments, the coating composition further comprises silica, glass fibre, or a combination thereof. In some embodiments, the coating composition further comprises (e.g. crystalline) fluoropolymer particles.

Also described are methods of coating a substrate and articles, especially telecommunication articles.

### BRIEF DESCRIPTION OF THE DRAWINGS

FIG. 1 depicts viscosity as a function of time for compositions with various amount of fluorinated alcohol.

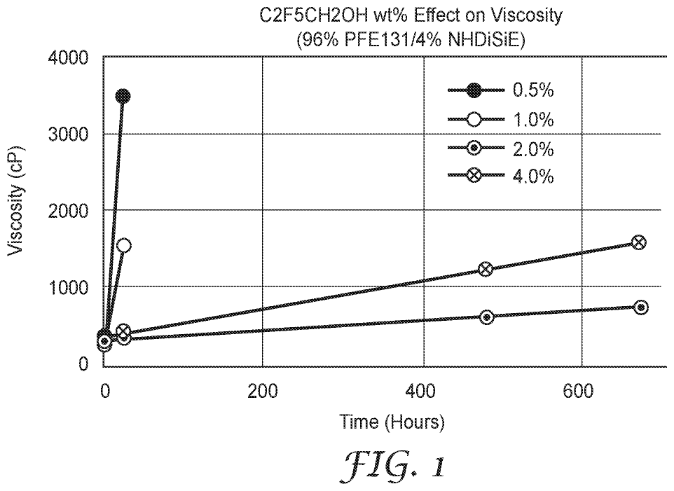

### DETAILED DESCRIPTION

Presently described is a coating composition comprising a fluoropolymer; a fluorinated solvent; and a fluorinated alcohol.

### Fluoropolymers

The fluoropolymer comprises a fluoropolymer are derived predominantly or exclusively from perfluorinated comonomers including tetrafluoroethene (TFE) and one or more of the unsaturated (e.g. alkenyl, vinyl) perfluorinated alkyl ethers. “Predominantly” as used herein means at least 80, 85, or 90% by weight based on the total weight of the fluoropolymer, of the polymerized units of the fluoropolymer are derived from such perfluorinated comonomers such as tetrafluoroethene (TFE) and one or more unsaturated perfluorinated alkyl ethers. In some embodiments, the fluoropolymer comprises at least 81, 82, 83, 84, 85, 86, 87, 88, 90, 91, 92, 93, 94, 95, 96, or 97% by weight or greater of such perfluorinated comonomers, based on the total weight of the fluoropolymer. The fluoropolymers may contain at least 40, 45, or 50% by weight of polymerized units derived from TFE. In some embodiments, the maximum amount of polymerized units derived from TFE is no greater than 60% or 55% by weight.

In some favored embodiments, the one or more unsaturated perfluorinated alkyl ethers are selected from the general formula:

R_{f}—O—(CF₂)ₙ—CF═CF₂

wherein n is 1 (allyl ether) or 0 (vinyl ether) and R_{f} represents a perfluoroalkyl residue which may be interrupted once or more than once by an oxygen atom. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched, and it may contain or not contain a cyclic unit. Specific examples of R_{f} include residues with one or more ether functions including but not limited to:

—(CF₂)—O—C₃F₇,

—(CF₂)₂—O—C₂F₅,

—(CF₂)ᵣ₃—O—CF₃,

—(CF₂—O)—C₃F₇,

—(CF₂—O)₂—C₂F₅,

—(CF₂—O)₃—CF₃,

—(CF₂CF₂—O)—C₃F₇,

—(CF₂CF₂—O)₂—C₂F₅,

—(CF₂CF₂—O)₃—CF₃,

Other specific examples for R_{f} include residues that do not contain an ether function and include but are not limited to —C₄F₉; —C₃F₇, —C₂F₅, —CF₃, wherein the C₄ and C₃ residues may be branched or linear, but preferably are linear.

The unsaturated perfluorinated alkyl either may comprise allyl or vinyl groups. Both have C═C double bonds. Whereas a perfluorinated vinyl group is CF₂═CF—; a perfluorinated allyl group is CF₂═CFCF₂—.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂═CF—CF₂—O—CF₃, CF₂═CF—CF₂—O—C₃F₇, CF₂═CF—CF₂—O—(CF₃)₃—O—CF₃.

Further examples include but are not limited to the vinyl ether described in European Patent EP 1,997,795.

In some embodiments, the (e.g. amorphous) fluoropolymer comprises polymerized units of at least one allyl ether, such as alkyl vinyl ether is CF₂═CFCF₂OCF₂CF₂CF₃. Such fluoropolymers are described in WO 2019/161153; incorporated herein by reference.

Perfluorinated ethers as described above are commercially available, for example from Anles Ltd., St. Petersburg, Russia and other companies or may be prepared according to methods described in U.S. Pat. No. 4,349,650 (Krespan) or European Patent EP 1,997,795, or by modifications thereof as known to a skilled person.

In some embodiments, the one or more unsaturated perfluorinated alkyl ethers comprises unsaturated cyclic perfluorinated alkyl ethers, such as 2,2-bistrifluoromethyl-4,5-difluoro-1,3 dioxole. In other embodiments, the fluoropolymer is substantially free of unsaturated cyclic perfluorinated alkyl ethers, such as 2,2-bistrifluoromethyl-4,5-difluoro-1,3 dioxole. By substantially free it is meant that the amount is zero or sufficiently low such the fluoropolymer properties are about the same.

The fluoropolymer typically comprises polymerized units derived from one or more of the unsaturated perfluorinated alkyl ethers (PAVE) (e.g. PMVE, PAAE or a combination thereof), in an amount of at least 10, 15, 20, 25, 30, 45, or 50% by weight, based on the total polymerized monomer units of the fluoropolymer. When the amount of polymerized units derived from one or more of the unsaturated perfluorinated alkyl ethers is less than 30 wt. %, the amorphous fluoropolymer typically comprises other comonomers such as HFP to reduce the crystallinity. In some embodiments, the fluoropolymer comprises no greater than 50, 45, 40, or 35% by weight of polymerized units derived from one or more of the unsaturated perfluorinated alkyl ethers (PMVE, PAAE or a combination thereof), based on the total polymerized monomer units of the fluoropolymer. The molar ratio of units derived from TFE to the perfluorinated alkyl ethers described above may be, for example, from 1:1 to 5:1. In some embodiments, the molar ratio ranges from 1.5:1 to 3:1.

In some embodiments, the one or more unsaturated perfluorinated alkyl ethers comprises unsaturated cyclic perfluorinated alkyl ethers, such as 2,2-bistrifluoromethyl-4,5-difluoro-1,3 dioxole. Amorphous fluoropolymer that comprise predominantly, or exclusively comprise, (e.g. repeating) polymerized units derived from two or more perfluorinated comonomers including tetrafluoroethene (TFE) and one or more unsaturated cyclic perfluorinated alkyl ethers, such as 2,2-bistrifluoromethyl-4,5-difluoro-1,3 dioxole are commercially available as “TEFLON™ AF”, “CYTOP™”, and “HYFLON™”.

Fluoropolymers comprising a sufficient amount of polymerized units of one or more of the unsaturated perfluorinated alkyl ethers are typically amorphous fluoropolymers. As used herein, amorphous fluoropolymers are materials that contain essentially no crystallinity or possess no significant melting point (peak maximum) as determined by differential scanning calorimetry in accordance with DIN EN ISO 11357-3:2013-04 under nitrogen flow and a heating rate of 10° C./min. Typically, amorphous fluoropolymers have a glass transition temperature (Tg) of less than 26° C., less than 20° C., or less than 0° C., and for example from −40° C. to 20° C., or −50° C. to 15° C., or −55° C. to 10° C. The fluoropolymers may typically have a Mooney viscosity (ML 1+10 at 121° C.) of from about 2 to about 150, for example from 10 to 100, or from 20 to 70. For amorphous polymers containing cyclic perfluorinated alky ether units, the glass transition temperature is typically at least 70° C., 80° C., or 90° C., and may range up to 220° C., 250° C., 270° C., or 290° C. The MFI (297° C./5 kg) is between 0.1-1000 g/10 min.

The fluorine content of the fluoropolymer is typically at least 60, 65, 66, 67, 68, 69, or 70 wt. % of the fluoropolymer and typically no greater than 76, 75, 74, or 73 wt. %. The fluorine content may be achieved by selecting the comonomers and their amounts accordingly.

Such highly-fluorinated amorphous fluoropolymers typically do not dissolve to the extent of at least 1 wt. %, at room temperature and standard pressure, in a hydrogen-containing organic liquid (e.g., it does not dissolve in any of methyl ethyl ketone (“MEK”), tetrahydrofuran (“THF”), ethyl acetate or N-methyl pyrrolidinone (“NMP”)).

The fluoropolymers may contain partially fluorinated or non-fluorinated comonomers and combinations thereof, although this is not preferred. Typical partially fluorinated comonomers include but are not limited to 1,1-difluoroethene (vinylidenefluoride, VDF) and vinyl fluoride (VF) or trifluorochloroethene or trichlorofluoroethene. Examples of non-fluorinated comonomers include but are not limited to ethene and propene. The amount of units derived from these comonomers include from 0 to 8% by weight based on the total weight of the fluoropolymer. In some embodiments, the concentration of such comonomer is no greater than 7, 6, 5, 4, 3, 2, or 1% by weight based on the total weight of the fluoropolymer.

In a preferred embodiment, the curable fluoropolymer is a perfluoroelastomer that comprises repeating units (exclusively) derived from the perfluorinated comonomers but may contain units derived from cure-site monomers and modifying monomers if desired. The cure-site monomers and modifying monomers may be partially fluorinated, not fluorinated or perfluorinated, and preferably are perfluorinated. The perfluoroelastomers may contain from 69 to 73, 74, or 75% fluorine by weight (based on the total amount of perfluoroelastomer). The fluorine content may be achieved by selecting the comonomers and their amounts accordingly.

The fluoropolymers can be prepared by methods known in the art, such as bulk, suspension, solution or aqueous emulsion polymerization. Various emulsifiers can be used as described in the art, including for example 3H-perfluoro-3-[(3-methoxy-propoxy)propanoic acid. For example, the polymerization process can be carried out by free radical polymerization of the monomers alone or as solutions, emulsions, or dispersions in an organic solvent or water. Seeded polymerizations may or may not be used. Curable fluoroelastomers that can be used also include commercially available fluoroelastomers, in particular perfluoroelastomers.

The fluoropolymers may have a monomodal or bi-modal or multi-modal weight distribution. The fluoropolymers may or may not have a core-shell structure. Core-shell polymers are polymers where towards the end of the polymerization, typically after at least 50% by mole of the comonomers are consumed, the comonomer composition or the ratio of the comonomers or the reaction speed is altered to create a shell of different composition.

### Cure Sites

In some embodiments, the fluoropolymer comprises a curable fluoropolymer that contains one or more cure sites. Cure sites are functional groups that react in the presence of a curing agent or a curing system to cross-link the polymers. The cure sites are typically introduced by copolymerizing cure-site monomers, which are functional comonomers already containing the cure sites or precursors thereof. One indication of crosslinking is that the dried and cured coating composition is not soluble in the fluorinated solvent of the coating.

The cure sites may be introduced into the polymer by using cure site monomers, i.e. functional monomers as will be described below, functional chain-transfer agents and starter molecules. The fluoroelastomers may contain cure sites that are reactive to more than one class of curing agents.

The curable fluoroelastomers may also contain cure sites in the backbone, as pendent groups, or cure sites at a terminal position. Cure sites within the fluoropolymer backbone can be introduced by using a suitable cure-site monomer. Cure site monomers are monomers containing one or more functional groups that can act as cure sites or contain a precursor that can be converted into a cure site.

In some embodiments, the cure sites comprise iodine or bromine atoms.

Iodine-containing cure site end groups can be introduced by using an iodine-containing chain transfer agent in the polymerization. Iodine-containing chain transfer agents will be described below in greater detail. Halogenated redox systems as described below may be used to introduce iodine end groups.

In addition to iodine cures sites, other cure sites may also be present, for example Br-containing cure sites or cure sites containing one or more nitrile groups. Br-containing cure sites may be introduced by Br-containing cure-site monomers.

Examples of cure-site comonomers include for instance:
(a) bromo- or iodo-(per)fluoroalkyl-(per)fluorovinylethers, for example including those having the formula:

ZRf—O—CX═CX₂

wherein each X may be the same or different and represents H or F, Z is Br or I, R_{f} is a C1-C12 (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂ or ZCF₂CF₂—O—CF₂CF₂CF₂—O—CF═CF₂ wherein Z represents Br of I; and
(b) bromo- or iodo perfluoroolefins such as those having the formula:

Z′—(R_{f})r-CX═CX₂

wherein each X independently represents H or F, Z′ is Br or I, R_{f} is a C₁-C₁₂ perfluoroalkylene, optionally containing chlorine atoms and r is 0 or 1; and
(c) non-fluorinated bromo and iodo-olefins such as vinyl bromide, vinyl iodide, 4-bromo-1-butene and 4-iodo-1-butene.

Specific examples include but are not limited to compounds according to (b) wherein X is H, for example compounds with X being H and R_{f} being a C1 to C3 perfluoroalkylene. Particular examples include: bromo- or iodo-trifluoroethene, 4-bromo-perfluorobutene-1, 4-iodo-perfluorobutene-1, or bromo- or iodo-fluoroolefins such as 1-iodo,2,2-difluroroethene, 1-bromo-2,2-difluoroethene, 4-iodo-3,3,4,4,-tetrafluorobutene-1 and 4-bromo-3,3,4,4-tetrafluorobutene-1; 6-iodo-3,3,4,4,5,5,6,6-octafluorohexene-1.

In some embodiments, the cure sites comprise chlorine atoms. Such cure-site monomers include those of the general formula: CX₁X₂═CY₁Y₂ where X₁, X₂ are independently H and F; Y₁ is H, F, or Cl; and Y₂ is Cl, a fluoroalkyl group (R_{F}) with at least one Cl substituent, a fluoroether group (OR_{F}) with at least one Cl substituent, or —CF₂—OR_{F}. The fluoroalkyl group (R_{F}) is typically a partially or fully fluorinated C₁-C₅ alkyl group. Examples of cure-site monomer with chlorine atoms include CF₂═CFCl, CF₂═CF—CF₂Cl, CF₂═CF—O—(CF₂)ₙ—Cl, n=1-4; CH₂═CHCl, CH₂═CCl₂.

Typically, the amount of iodine or bromine or chlorine or their combination in the fluoropolymer is between 0.001 and 5%, preferably between 0.01 and 2.5%, or 0.1 to 1% or 0.2 to 0.6% by weight with respect to the total weight of the fluoropolymer. In one embodiment the curable fluoropolymers contain between 0.001 and 5%, preferably between 0.01 and 2.5%, or 0.1 to 1%, more preferably between 0.2 to 0.6% by weight of iodine based on the total weight of the fluoropolymer.

In other embodiments, halogenated chain transfer agents can be utilized to provide terminal cure sites. Chain transfer agents are compounds capable of reacting with the propagating polymer chain and terminating the chain propagation. Examples of chain transfer agents reported for the production of fluoroelastomers include those having the formula RIₓ, wherein R is an x-valent fluoroalkyl or fluoroalkylene radical having from 1 to 12 carbon atoms, which, may be interrupted by one or more ether oxygens and may also contain chlorine and/or bromine atoms. R may be R_{f} and R_{f} may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

R_{f}—CF(I)—(CX₂)ₙ—(CX₂CXR)ₘO—R″f-Oₖ—(CXR′CX₂)ₚ—(CX₂)_{q}—CF(I)—R′_{f}

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

The fluoropolymers may or may not contain units derived from at least one modifying monomer. The modifying monomers may introduce branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

CF₂═CF—(CF₂)ₙ—O—(R_{f})—O—(CF₂)ₘ—CF═CF₂

wherein n and m are independent from each other either 1 or 0 and wherein R_{f} represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

CF₂═CF—O—(CF₂)ₙ—O—CF═CF₂

wherein n is an integer between 1 and 10, preferably 2 to 6., e.g. n may be 1, 2, 3, 4, 5, 6 or 7. More preferably, n represents an uneven integer, for example 1, 3, 5 or 7.

Further specific examples include bisolefinic ethers according the general formula

CF₂═CF—(CF₂)ₙ—O—(CF₂)ₚ—O—(CF₂)ₘ—CF═CF₂

wherein n and m are independently either 1 or 0 and p is an integer from 1 to 10 or 2 to 6. For example, n may be selected to represent 1, 2, 3, 4, 5, 6 or 7, preferably, 1, 3, 5 or 7.

Further suitable perfluorinated bisolefinic ethers can be represented by the formula

CF₂═CF—(CF₂)ₚ—O—(R_{af}O)ₙ(R_{bf}O)ₘ—(CF₂)_{q}—CF═CF₂

wherein R_{af} and R_{bf} are different linear or branched perfluoroalkylene groups of 1-10 carbon atoms, in particular, 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independently 1 or 0.

In another embodiment, the perfluorinated bisolefinic ethers can be represented by the formula just described wherein m, n, and p are zero and q is 1-4.

Modifying monomers can be prepared by methods known in the art and are commercially available, for example, from Anles Ltd., St. Petersburg, Russia.

Preferably, (e.g. ethylenically unsaturated) modifying monomers are not used or only used in low amounts. Typical amounts include from 0 to 5%, or from 0 to 1.4% by weight based on the total weight of the fluoropolymer. Modifiers may be present, for example, in amounts from about 0.1% to about 1.2% or from about 0.3% to about 0.8% by weight based on the total weight of fluoropolymer. Combinations of modifiers may also be used. Further, in typical embodiments, the fluoropolymer composition comprises no greater than 8, 7, 6, 5, 4, 3, 2, 1 or 0.1 wt.-% of polymerized units with (e.g. (meth)acrylate) ester-containing moieties.

Fluoropolymer with halogen cure sites (iodine, bromine, and chlorine) can be favored for UV curing as described in WO2021/091864; incorporated herein by reference. For thermal or e-beam curing, the fluoropolymers with nitrile-containing cure cites can alternatively be employed. Further, the inclusion of cure sites, such as nitrile, can improve adhesion of the fluoropolymer composition to a (e.g. copper) substrate even in the absence of crosslinking.

When a combination of fluoropolymers with different cure sites are utilized the composition may be characterized as dual curing, containing different cure sites that are reactive to different curing systems.

In some embodiments, the fluoropolymer contains nitrile-containing cure sites as well as corresponding amidines, amidine salts, imide, amides, amide/imide, and ammonium salts. Fluoropolymers with nitrile-containing cure sites are known, such as described in U.S. Pat. Nos. 6,720,360 and 7,019,082.

Nitrile-containing cure sites may be reactive to other cure systems for example, but not limited to, bisphenol curing systems, peroxide curing systems, triazine curing systems, and especially amine curing systems. Examples of nitrile containing cure site monomers correspond to the following formula:

CF₂═CF—CF₂—O—R_{f}—CN;

CF₂═CFO(CF₂)ᵣCN;

CF₂═CFO[CF₂CF(CF₃)O]ₚ(CF₂)ᵥOCF(CF₃)CN;

CF₂═CF[OCF₂CF(CF₃)]ₖO(CF₂)ᵤCN;

wherein, r represents an integer of 2 to 12; p represents an integer of 0 to 4; k represents 1 or 2; v represents an integer of 0 to 6; u represents an integer of 1 to 6, Rf is a perfluoroalkylene or a bivalent perfluoroether group. Specific examples of nitrile containing fluorinated monomers include but are not limited to perfluoro (8-cyano-5-methyl-3,6-dioxa-1-octene), CF₂═CFO(CF₂)₅CN, and CF₂═CFO(CF₂)₃OCF(CF₃)CN.

In some embodiments, the amount of nitrile-containing cure site comonomer is typically at least 0.5, 1, 1.5, 2, 2.5, 3, 3.5, 4, 4.5 or 5% by weight and typically no greater than 10% by weight; based on the total weight of the fluoropolymer.

The composition may comprise a curable fluoropolymer and a second fluoropolymer that lacks (e.g. halogen or nitrile) cure sites. The amount of fluoropolymer lacking cure sites is typically less than 50, 45, 40, 35, 30, 25, 20, 15, 10, or 5 wt. % of the total fluoropolymer. In this embodiment, the composition typically has a sufficient amount of fluoropolymer with cure sites such that adequate adhesion and/or crosslinking is achieved.

### Fluorinated Solvent

The fluoropolymer (coating solution) compositions comprises at least one fluorinated solvent. In typical embodiments, the fluoropolymer is soluble in the fluorinated solvent. In other embodiments, the fluoropolymer is dispersible in the solvent. The solvent is typically present in an amount of at least 25% by weight based on the total weight of the coating solution composition. In some embodiments, the solvent is present in an amount of at least 30, 35, 40, 45, 50, 55, 60, 65, 70, 75, 80, 85, 90, 95% or greater based on the total weight of the coating solution composition.

The fluoropolymer (coating solution) composition typically comprises at least 0.01, 0.02, 0.03, 0.03, 0.04, 0.04, 0.05, 0.06, 0.7, 0.8, 0.9 or 1% by weight of fluoropolymer, based on the weight of the total coating solution composition. In some embodiments, the fluoropolymer coating solution composition comprises at least 2, 3, 4, or 5% by weight of fluoropolymer. In some embodiments, the fluoropolymer coating solution composition comprises at least 6, 7, 8, 9 or 10% by weight of fluoropolymer. The fluoropolymer coating solution composition typically comprises no greater than 50, 45, 40, 35, 30, 25, or 20% by weight of fluoropolymer, based on the weight of the total coating solution composition.

In typical embodiments, the one or more of the fluoropolymer(s) of the composition are soluble in a fluorinated solvent. The one or more of the fluoropolymer(s) of the composition are soluble in a fluorinated solvent, such as HFE-7300, at a fluoropolymer concentration of at least 10 wt. % solids. In some embodiments, the one or more of the fluoropolymer(s) of the composition are soluble in a fluorinated solvent, such as HFE-7300, at a fluoropolymer concentration of at least 15, 20, 25, 30, 35, 40, 45, or 50 wt. % solids. In other embodiments, the fluoropolymer is dispersible in the fluorinated solvent at such concentrations, yet is not soluble in the fluorinated solvent.

Optimum amounts of solvent and fluoropolymers may depend on the final application and may vary. For example, to provide thin coatings, very dilute solutions of fluoropolymer in the solvent may be desired, for example amounts of from 0.01% by weight to 5% by weight of fluoropolymer. Also for application by spray coating composition of low viscosity may be preferred over solutions with high viscosity. The concentration of fluoropolymer in the solution affects the viscosity and may be adjusted accordingly. An advantage of the present disclosure is that also solutions with high concentrations of fluoropolymer can be prepared that still provide clear liquid composition of low viscosity.

In some embodiments, the fluoropolymer coating solution compositions may be liquids. The liquids may have, for example, a viscosity of less than 2,000 mPas at room temperature (20° C.+/−2° C.). In other embodiments, the fluoropolymer coating solution compositions are pastes. The pastes may have, for example, a viscosity of from 2,000 to 100.000 mPas at room temperature (20° C.+/−2° C.).

The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C.

The solvent is partially fluorinated or perfluorinated. Thus, the solvent is non-aqueous. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent has a global warming potential (GWP, 100 year ITH) of less than 1000, 900, 800, 700, 600, 500, 400, 300, 200 or 100. The GWP is typically greater than 0 and may be at least 10, 20, 30, 40, 50, 60, 70, or 80.

As used herein, GWP is a relative measure of the global warming potential of a compound based on the structure of the compound. The GWP of a compound, as defined by the Intergovernmental Panel on Climate Change (IPCC) in 1990 and updated in subsequent reports, is calculated as the warming due to the release of 1 kilogram of a compound relative to the warming due to the release of 1 kilogram of CO₂ over a specified integration time horizon (ITH).

$${GWP}_{x} = \frac{{\int }_{0}^{ITH} {F}_{x} {C}_{xo} exp ( - t / {τ}_{x} ) dt}{{\int }_{0}^{ITH} {F}_{{CO}_{2}} {C}_{{CO}_{2}} ( t ) dt}$$

where F is the radiative forcing per unit mass of a compound (the change in the flux of radiation through the atmosphere due to the IR absorbance of that compound), Cₒ is the atmospheric concentration of a compound at initial time, τ is the atmospheric lifetime of a compound, τ is time, and x is the compound of interest.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

Rf—O—R

wherein Rf is a perfluorinated or partially fluorinated alkyl or (poly)ether group and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²/R_{f}³)CF—O—R.

When Rf is a tertiary alkyl residue the carbon atom linked to the ether atom is also linked to three carbon atoms of three partially and/or perfluorinated alkyl chains and R_{f} corresponds to (R_{f}⁴R_{f}⁵R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary, secondary and/or tertiary alkyl residues may be used.

An example of a solvent comprising a partially fluorinated alkyl group includes C₃F₇OCHFCF₃ (CAS No. 3330-15-2).

An example of a solvent wherein Rf comprises a perfluorinated (poly)ether is C₃F₇OCF(CF₃)CF₂OCHFCF₃ (CAS No. 3330-14-1).

In some embodiments, the partially fluorinated ether solvent corresponds to the formula:

CpF2p+1-O-CqH2q+1

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, MN.

The fluorinated (e.g. ethers and polyethers) solvents may be used alone or in combination with other solvents, which may be fluorochemical solvents or non-fluorochemical solvents. When a non-fluorochemical solvent is combined with a fluorinated solvent, the concentration non-fluorochemical solvent is typically less than 30, 25, 20, 15, 10 or 5 wt-% with respect to the total amount of solvent. Representative non-fluorochemical solvents include ketones such as acetone, MEK, methyl isobutyl ketone, methyl amyl ketone and NMP; ethers such as tetrahydrofuran, 2-methyl tetrahydrofuran and methyl tetrahydrofurfuryl ether; esters such as methyl acetate, ethyl acetate and butyl acetate; cyclic esters such as delta-valerolactone and gamma-valerolactone.

As described in WO2021/091864, coating composition comprising fluoropolymer, fluorinated solvent, and curing agents are “stable, meaning that the coating composition remains homogeneous when stored for at least 24 hours at room temperature in a sealed container. In some embodiments, the coating composition is stable for one week or more. “Homogeneous” refers to a coating composition that does not exhibit a visibly separate precipitate or visibly separate layer when freshly shaken, placed in a 100 ml glass container and allowed to stand at room temperature for at least 4 hours. However, industry would find advantage in coating compositions having improved stability. In some embodiments, the coating compositions as described herein further comprising a fluorinated alcohol are stable for 48, 72, or 96 hours or greater. In some embodiments, the coating compositions as described herein further comprising a fluorinated alcohol are stable for 100, 200, 300, 400, 500, or 600 hours or greater.

### Fluorinated Alcohol

The fluorinated alcohol comprises a single hydroxy group or more than one hydroxy groups. In some embodiments, the fluorinated alcohol comprises a linear, branched or cyclic (per)fluoroalkyl or (per)fluoroalkylene group. In one embodiment, linear (per)fluorinated alcohols provided greater improvements in stability than branched (per)fluorinated alcohols. In some embodiments, the (per)fluoroalkyl or (per)fluoroalkylene group may optionally be interrupted with heteroatoms (e.g. O, N, S).

In some embodiments, the fluorinated alcohol has the following formula:

Rf—(CH₂)ₙOH)ₚ

wherein Rf is a (per)fluoroalkyl or (per)fluoroalkylene group. The number of CH₂ groups can be 0, 1, or greater than 1. In some embodiments, n is 1. The alcohol typically comprises a single —OH group (i.e. p is 1). However, low molecular weight diols and polyols may also be suitable (i.e. p is 2 or 3).

In typical embodiments, Rf is a perfluorinated C1 to C4 alkyl or C2 to C4 alkylene group, i.e. perfluromethyl, perfluoroethyl, perfluorethylene, perfluoropropyl, perfluoropropylene, perfluorbutyl, or perflurobutylene. Representative fluorinated alcohols include for example, CF₃CH₂OH, C₂F₅CH₂OH, n-C₃F₇CH₂OH, (CF₃)₂CFCH₂OH, (CF₃)₂CFCF₂CH₂OH, CF₃OCF₂CF₂CH₂OH, HCF₂CF₂CH₂OH, H(CF₂)₄CH₂OH, n-C₃F₇CH₂CH₂OH, and (CF₂CH₂OH)₂.

In some embodiments, the fluorinated alcohol also typically has a boiling point below 200° C. so that it can be easily removed. In some embodiments, the fluorinated alcohol has a boiling point below 190, 180, 170, 160, 150, 140, 130, 120, 110, or 100° C. In some embodiments, the fluorinated alcohol has a boiling point of at least 50, 55, 60, 65, or 70° C. The boiling point of the fluorinated alcohol may differ from the fluorinated solvent by at least 5 or 10 degrees to facilitate separating the fluorinated alcohol from the fluorinated solvent when removing the solvent from the coating composition.

In some embodiments, the fluoropolymer is insoluble in the fluorinated alcohol at a concentration of 10 wt-% fluoropolymer.

As demonstrated in the forthcoming examples, the fluorinated alcohols has been found to significantly improve shelf-life stability of the coating composition. Such improvement can be accompanied by maintaining other physical properties of the dried and optionally cured coating composition, such as Dk and Df.

### Alkoxy Silane & Amine Compounds

In some embodiments, the fluorinated alcohol improves the stability of a coating composition comprising a compound with one or more alkoxy silane groups. Without intending to be bound by theory it is surmised that the fluorinated alcohol can reduce hydrolysis of the alkoxy silane to Si—OH.

In some embodiments, the fluorinated alcohol improves the stability of a coating composition comprising a compound with one or more amine groups. Without intending to be bound by theory it is surmised that the fluorinated alcohol can function as a weak acid to prevent premature curing of an amine with amine-reactive cure sites.

The amine may be aliphatic or aromatic. Amine compounds can be utilized to provide a crosslinked fluoropolymer layer by (e.g. thermally) curing a fluoropolymer with (e.g. nitrile) cure sites utilizing an amine cuing agent. Amine compounds can also be utilized in combination with ethylenically unsaturated compound to provide a crosslinked fluoropolymer layer by (e.g. radiation) curing a fluoropolymer having halogen cure sites.

In some embodiments, the compound may be characterized as a crosslinking compound that comprises at least two amine groups, at least two alkoxy silane groups, or at least one amine and at least one alkoxy silane groups.

In some embodiments, the compound comprising one or more alkoxy silane groups and/or one or more amine groups may be a fluorinated. Such compound may be a fluorinated curing agent such as described in 83602US002; incorporated herein by reference. In some embodiments, the fluorinated curing agent is soluble in the fluorinated solvent.

In other embodiments, the curing agent is a non-fluorinated curing agent such as described in WO2021/091864; incorporated herein by reference.

Combinations of fluorinated and non-fluorinated curing agents may also be utilized.

In some embodiments, the amine may be characterized as an amino-substituted organosilane ester or ester equivalent that bear on the silicon atom at least one, and preferably 2 or 3 ester or ester equivalent groups. Ester equivalents are known to those skilled in the art and include compounds such as silane amides (RNR′Si), silane alkanoates (RC(O)OSi), Si—O—Si, SiN(R)—Si, SiSR and RCONR′Si compounds that are thermally and/or catalytically displaceable by R″OH. R and R′ are independently chosen and can include hydrogen, alkyl, arylalkyl, alkenyl, alkynyl, cycloalkyl, and substituted analogs such as alkoxyalkyl, aminoalkyl, and alkylaminoalkyl. R″ may be the same as R and R′, except it may not be H. These ester equivalents may also be cyclic such as those derived from ethylene glycol, ethanolamine, ethylenediamine (e.g. N-[3-(trimethoxylsilyl)propyl] ethylenediamine) and their amides.

Another such cyclic example of an ester equivalent is

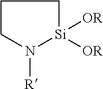

In this cyclic example R′ is as defined in the preceding sentence, except that it may not be aryl. 3-aminopropyl alkoxysilanes are well known to cyclize upon heating, and these RNHSi compounds would be useful in this invention. Preferably the amino-substituted organosilane ester or ester equivalent has ester groups such as methoxy that are easily volatilized as methanol. The amino-substituted organosilane must have at least one ester equivalent; for example, it may be a trialkoxysilane.

For example, the amino-substituted organosilane may have the formula

(Z₂N-L-SiX′X″X″′), wherein
Z is hydrogen, alkyl, or substituted aryl or alkyl including amino-substituted alkyl; and L is a divalent straight chain C1-12 alkylene or may comprise a C3-8 cycloalkylene, 3-8 membered ring heterocycloalkylene, C2-12 alkenylene, C4-8 cycloalkenylene, 3-8 membered ring heterocycloalkenylene or heteroarylene unit; and each of X′, X″ and X″′ is a C1-18 alkyl, halogen, C1-8 alkoxy, C1-8 alkylcarbonyloxy, or amino group, with the proviso that at least one of X′, X″, and X″′ is a labile group. Further, any two or all of X′, X″ and X″′ may be joined through a covalent bond. The amino group may be an alkylamino group.

L may be divalent aromatic or may be interrupted by one or more divalent aromatic groups or heteroatomic groups. The aromatic group may include a heteroaromatic. The heteroatom is preferably nitrogen, sulfur or oxygen. L is optionally substituted with C1-4 alkyl, C2-4 alkenyl, C2-4 alkynyl, C1-4 alkoxy, amino, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl. L is further optionally interrupted by —O—, —S—, —N(Rc)-, —N(Rc)-C(O)—, —N(Rc)-C(O)—O—, —O—C(O)—N(Rc)-, —N(Rc)-C(O)—N(Rd)-, —O—C(O)—, —C(O)—O—, or —O—C(O)—O—. Each of Re and Rd, independently, is hydrogen, alkyl, alkenyl, alkynyl, alkoxyalkyl, aminoalkyl (primary, secondary or tertiary), or haloalkyl.

Examples of amino-substituted organosilanes include 3-aminopropyltrimethoxysilane (SILQUEST A-1110), 3-aminopropyltriethoxysilane (SILQUEST A-1100), bis(3-trimethoxysilylpropy)amine, bis(3-triethoxysilylpropy)amine, bis(3-trimethoxysilylpropy)n-methylamine, 3-(2-aminoethyl)aminopropyltrimethoxysilane (SILQUEST A-1120), SILQUEST A-1130, (aminoethylaminomethyl)phenethyltrimethoxysilane, (aminoethylaminomethyl)-phenethyltriethoxysilane, N-(2-aminoethyl)-3-aminopropylmethyldimethoxysilane (SILQUEST A-2120), bis-(.gamma.-triethoxysilylpropyl)amine (SILQUEST A-1170), N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl)phenyltrimethoxysilane, 3-aminopropyltris(methoxyethoxyethoxy)silane, 3-aminopropylmethyldiethoxy-silane, oligomeric aminosilanes such as DYNASYLAN 1146, 3-(N-methylamino)propyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane, and the following cyclic compounds:

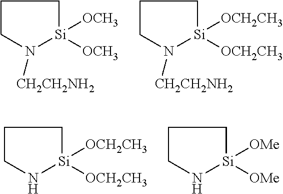

A bis-silyl urea [RO)₃Si(CH₂)NR]₂C═O is another example of an amino-substituted organosilane ester or ester equivalent.

In some embodiments, the curing agent comprises a blocked amine group and an alkoxy silane group. Such blocked amine curing agent can be characterized by the following general formula:

(R⁴O)₃—Si—(CH₂)ₘ—N═C(R1)(R2)

wherein R¹ and R² are independently selected from a linear or branched alkyl group comprising 1 to 6 carbon atoms as previously described. R′ is independently selected from a linear or branched alkyl group comprising 1 to 6 carbon atoms, m is an integer from 1 to 4, and each R⁴ is independently a C1 or C2 alkyl group.

One illustrative curing agent comprising a blocked amine group and an alkoxy silane group is N-(1,3-dimethylbutylidene)aminopropyl-triethoxysilane, depicted as follows:

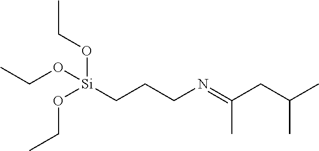 [SMILES: CCO[Si](CCC/N=C(\C)CC(C)C)(OCC)OCC]

Such curing agent is available from Gelest and from 3M as “3M™ Dynamer™ Rubber Curative RC5125”. Blocked amines are additional examples of electron donor precursors.

In some embodiments, the amine curing agent comprises an aziridine group and an alkoxy silane group. Such compounds are known for examples from U.S. Pat. No. 3,243,429; incorporated herein by reference. Aziridine alkoxy silane compounds may have the general structure:

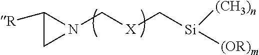

wherein R″ is hydrogen or a C₁-C₄ alkyl (e.g. methyl);
X is a bond, a divalent atom, or a divalent linking group;
n is 0, 1 or 2;
m is 1, 2, or 3; and
and the sum or n+m is 3.

One representative compound is 3-(2-methylaziridinyl)ethylcarboxylpropyltriethoxysilane.

In some embodiment, the ethylenically unsaturated curing agent comprises at least one ethylenically unsaturated group and at least one alkoxy silane group. Suitable curing agents include for example (meth)acryloy alkoxy silanes such as 3-(methacryloxy)propyltrimethoxysilane, 3-(methacryloxy)propylmethyldimethoxysilane, 3-(acryloyloxypropyl)methyl dimethoxysilane, 3-(methacryloyloxy)propyldimethylmethoxysilane, and 3-(acryloxypropyl) dimethylmethoxysilane. In some embodiments, the amount of (meth)acryloy alkoxy silanes is at least 2, 3, 4, or 5 wt. % to achieve a highly crosslinked fluoropolymer.

Suitable alkenyl alkoxy silanes include vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and allyltriethoxysilane.

In some embodiments, the ethylenically unsaturated curing agent may have the general formula

X¹-L¹-SiRₘ(OR₁)₃₋ₘ;
wherein X¹ is an ethylenically unsaturated group, such as (meth)acryl or vinyl;
L¹ is an organic divalent linking group having 1 to 12 carbon atoms;
R is independently C₁-C₄ alkyl and most typically methyl or ethyl;
R¹ is independently H or C₁-C₄ alkyl and most typically methyl or ethyl; and
m ranges from 0 to 2.

In typical embodiments, L¹ is an alkylene group. In some embodiments, L¹ is an alkylene group having 1, 2 or 3 carbon atoms. In other embodiments, L¹ comprises or consists of an aromatic group such as phenyl or (e.g. C₁-C₄) alkyl phenyl.

In some embodiments, such alkoxy silanes may be characterized as “non-functional” having the chemical formula:

R²Si(OR¹)ₘ
wherein R¹ is independently alkyl as previously described;
R² is independently hydrogen, alkyl, aryl, alkaryl, or OR¹; and
m ranges from 1 to 3, and is typically 2 or 3 as previously described.

Suitable alkoxy silanes of the formula R²Si(OR¹)ₘ include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane dimethyldimethoxysilane and dimethyldiethoxysilane.

Preferably, the alkyl group(s) of the alkoxy silanes comprises from 1 to 6, more preferably 1 to 4 carbon atoms. Preferred alkoxysilanes for use herein are selected from the group consisting of tetra methoxysilane, tetra ethoxysilane, methyl triethoxysilane, dimethyldiethoxysilane, and any mixtures thereof. A preferred alkoxysilane for use herein comprises tetraethoxysilane (TEOS). The alkoxy silane lacking organofunctional groups utilized in the method of making the coating composition may be partially hydrolyzed, such as in the case of partially hydrolyzed tetramethoxysilane (TMOS) available from Mitsuibishi Chemical Company under the trade designation “MS-51”.

When present, the amount of alkoxy silane compound that lacks functionality (e.g. TESO) is typically at least 0.01, 0.02, 0.03, 0.04, 0.05, 0.06, 0.07, 0.08, 0.09, 0.1, 0.2, 0.3, 0.4, or 0.5% by weight solids (i.e. excluding the solvent of the coating composition). In some embodiments, the amount of alkoxy silane compound that lacks functionality is no greater than 5, 4.5, 4, 3.5, or 3% by weight solids.

Various other non-fluorinated and fluroinated amine compounds with and without alkoxy silane groups are described in the literature, including for example amidines, bis(aminophenols) and bis(anminothiophenols).

The compounds comprising one or more alkoxy silane groups and/or one or more amine groups are typically present in an amount of at least 0.5, 1, 1.5, or 2 wt. % based on the total weight of the fluoropolymer. The maximum amount of fluorinated curing agents is typically no greater than 10, 9, 8, 7, 6, or 5 wt. % based on the total weight of the fluoropolymer.

The compounds comprising one or more alkoxy silane groups and/or one or more amine groups may be included in the coating composition at the time of manufacture of the coating composition. Alternatively, the coating composition (as manufactured) may be provided lacking such compounds. Such compounds may be subsequently added prior to the time of applying the coating composition to a substrate.

### Crystalline Fluoropolymer

In some embodiments, the composition further comprises crystalline fluoropolymer. The crystalline fluoropolymer may be present as particles. Alternatively, the crystalline fluoropolymer may be present as a second phase that may be formed by sintering the crystalline fluoropolymer particles at a temperature at or above the melting temperature of the crystalline fluoropolymer particles or melting and extruding the fluoropolymer composition.

In some embodiments, the fluoropolymer particles may be characterized as an “agglomerate” (e.g. of latex particles), meaning a weak association between primary particles such as particles held together by charge or polarity. Agglomerates are typically physically broken down into smaller entities such as primary particles during preparation of the coating solution. In other embodiments, the fluoropolymer particles may be characterized as an “aggregate”, meaning strongly bonded or fused particles, such as covalently bonded particles or thermally bonded particles prepared by processes such as sintering, electric arc, flame hydrolysis, or plasma. Aggregates are typically not broken down into smaller entities such as primary particles during preparation of the coating solution. “Primary particle size” refers to the mean diameter of a single (non-aggregate, non-agglomerate) particle.

In one embodiment, such coating composition is prepared by blending a latex containing (e.g. crystalline) fluoropolymer particles with a latex containing amorphous fluoropolymer particles.

The latexes can be combined by any suitable manner such as by vortex mixing for 1-2 minutes. The method further comprises coagulating the mixture of latex particles. Coagulation may be carried out, for example, by chilling (e.g., freezing) the blended latexes or by adding a suitable salt (e.g., magnesium chloride). Chilling is especially desirable for coatings that will be used in semiconductor manufacturing and other applications where the introduction of salts may be undesirable. The method further comprising optionally washing the coagulated mixture of amorphous fluoropolymer particles and crystalline fluoropolymer particles. The washing step may substantially remove emulsifiers or other surfactants from the mixture and can assist in obtaining a well-mixed blend of substantially unagglomerated dry particles. In some embodiments, the surfactant level of the resulting dry particle mixture may, for example, be less than 0.10% by weight, less than 0.05% by weight or less than 0.01% by weight. The method further comprises drying the coagulated latex mixture. The coagulated latex mixture can be dried by any suitable means such as air drying or oven drying. In one embodiment, the coagulated latex mixture can be dried at 100° C. for 1-2 hours.

In some embodiments, the dried coagulated latex mixture can be dissolved in a solvent suitable for dissolving the amorphous fluoropolymer particles to form a stable coating composition containing a homogeneous dispersion of the crystalline fluoropolymer particles in a solution of the amorphous fluoropolymer. In other embodiments, the dried coagulated latex mixture can be thermally processed.

The coating solution can be utilized to provide a coating on a substrate by applying a layer of the coating composition to a surface of a substrates and drying (i.e. removing the fluorinated solvent by evaporation) the coating composition. In some embodiments, the method further comprises heating the coated substrate to a temperature above the melt temperature of the fluoropolymer particles to sinter the fluoropolymer particles.

In some embodiments, the method further comprises rubbing (e.g. buffing, polishing) the dried layer thereby forming an amorphous fluoropolymer binder layer containing (e.g. crystalline) micron and optionally submicron fluoropolymer particles. A variety of rubbing techniques can be employed at the time of coating formation or later when the coated article is used or about to be used. Simply wiping or buffing the coating a few times using a cheesecloth or other suitable woven, nonwoven or knit fabric will often suffice to form the desired thin layer. Those skilled in the art will appreciate that many other rubbing techniques may be employed. Rubbing can also reduce haze in the cured coating.

The crystalline fluoropolymer particles at the coating surface forms a thin, continuous or nearly continuous fluoropolymer surface layer disposed on the underlying coating comprised of the amorphous fluoropolymer. In preferred embodiments the thin crystalline fluoropolymer layer is relatively uniformly smeared over the underlying coating and appears to be thinner and more uniform than might be the case if the fluoropolymer particles had merely undergone fibrillation (e.g., due to orientation or other stretching).

Average roughness (Ra) of the surface is the arithmetic average of the absolute values of the surface height deviation measured from the mean plane. The fluoropolymer layer or fluoropolymer film has a low average roughness. In some embodiments, Ra is at least 40 or 50 nm, ranging up to 100 nm before rubbing. In some embodiments, the surface after rubbing is at least 10, 20, 30, 40, 50 or 60% smoother. In some embodiments, Ra is less than 35, 30, 25, or 20 nm after rubbing.

When a thin coating is prepared from micron sized fluoropolymer particles the average roughness can be greater. In some embodiments, the average roughness is micron sized. However, when the thickness of the coating or fluoropolymer film is greater than the particle size of the (e.g. crystalline) fluoropolymer particles, the surface of the fluoropolymer coating or film can have a low average roughness as previously described.

An advantage of the coating compositions described herein is that the coating compositions can be used to prepare coatings of high or low thickness. In some embodiments, the dried and cured coating has a thickness of 0.1 microns to 10 mils. In some embodiments, the dried and cured coating thickness is at least 0.2, 0.3, 0.4, 0.5, or 0.6 microns. In some embodiments, the dried and cured coating thickness is at least 1, 2, 3, 4, 5, 6, 7, 8, 9, or 10 microns ranging up to 100, 150, or 200 microns.

A variety of crystalline fluoropolymer particles may be employed including mixtures of different crystalline fluoropolymer particles. The crystalline fluoropolymer particles typically have high crystallinity and therefore a significant melting point (peak maximum) as determined by differential scanning calorimetry in accordance with DIN EN ISO 11357-3:2013-04 under nitrogen flow and a heating rate of 10° C./min. Thus, the fluoropolymer particles are typically thermoplastic.

For example, the crystalline fluoropolymer (e.g. particles) may include particles of fluoropolymers having a Tm of at least 100, 110, 120, or 130° C. In some embodiments, the crystalline fluoropolymer (e.g. particles) may include particles of fluoropolymers having a Tm no greater than 350, 340, 330, 320, 310 or 300° C.

The crystalline fluoropolymer (e.g. particles) typically have a fluorine content greater than about 50 weight percent. Also, the fluoropolymer (e.g. particles) may include fluoropolymers having a fluorine content between about 50 and about 76 weight percent, between about 60 and about 76 weight percent, or between about 65 and about 76 weight percent.

Representative crystalline fluoropolymers include, for example, perfluorinated fluoropolymers such as 3M™ Dyneon™ PTFE Dispersions TF 5032Z, TF 5033Z, TF 5035Z, TF 5050Z, TF 5135GZ, and TF 5070GZ; and 3M™ Dyneon™ Fluorothermoplastic Dispersions PFA 6900GZ, PFA 6910GZ, FEP 6300GZ, THV 221, THV 340Z, and THV 800. Other suitable fluoropolymer particles are available from suppliers such as Asahi Glass, Solvay Solexis, and Daikin Industries and will be familiar to those skilled in the art.

Commercial aqueous dispersion usually contain non-ionic and/or ionic surfactants at concentration up to 5 to 10 wt. %. These surfactants are substantially removed by washing the coagulated blends. A residual surfactant concentration of less than 1, 0.05, or 0.01 wt. % may be present. Quite often it is more convenient to use the “as polymerized” aqueous fluoropolymer-latexes as they do not contain such higher contents of non-ionic/ionic surfactants.

As previously described, the crystalline fluoropolymers have a melt point that can be determined by DSC. Crystallinity depends on the selection and concentration of polymerized monomers of the fluoropolymer. For example, PTFE homopolymers (containing 100% TFE-units) have a melting point (Tm) above 340° C. The addition of comonomers, such as the unsaturated (per)fluorinated alkyl ethers, reduces the Tm. For example, when the fluoropolymer contains about 3-5 wt. % of polymerized units of such comonomer, the Tm is about 310° C. As yet another example, when the fluoropolymer contains about 15-20 wt. % of polymerized units of HFP, the Tm is about 260-270° C. As yet another example, when the fluoropolymer contains 30 wt. % of polymerized units of (per)fluorinated alkyl ethers (e.g. PMVE) or other comonomer(s) that reduce the crystallinity the fluoropolymer no longer has a detectable melting point via DSC, and thus is characterized as being amorphous.

In some embodiments, the crystalline fluoropolymer (e.g. particles) contain at least 40, 45, 50, 55, 60, 65, 70, 75, 80, 85, 90, 95 or about 100 wt. % of polymerized units of TFE. The crystalline fluoropolymer (e.g. particles) typically have a greater amount of polymerized units of TFE than the crosslinked fluoropolymer. More typically the crystalline fluoropolymer particles contain at least 85, 90, 95 or about 100 wt. % of polymerized units of TFE. Further, the crystalline fluoropolymer (e.g. particles) typically comprise a lower concentration of unsaturated (per)fluorinated alkyl ethers (e.g. PMVE) than the amorphous flurorpolymer. In typical embodiments, the crystalline fluoropolymer (e.g. particles) contains less than 30, 25, 20, 15, 14, 13, 12, 11, 10, 9, 8, 7, 6, or 5 wt. % of polymerized units of (per)fluorinated alkyl ethers (e.g. PMVE).

In some embodiments, the crystalline fluoropolymers are copolymers formed from the constituent monomers known as tetrafluoroethylene (“TFE”), hexafluoropropylene (“HFP”), and vinylidene fluoride (“VDF,” “VF2,”). The monomer structures for these constituents are shown below:

TFE: CF₂═CF₂ (1)

VDF: CH₂═CF₂ (2)

HFP: CF₂═CF—CF₃ (3)

In some embodiments, the crystalline fluoropolymer consists of at least two of the constituent monomers (HFP and VDF), and in some embodiments all three of the constituents monomers in varying amounts.

The Tm depends on the amounts of TFE, HFP, and VDF. For example, a fluoropolymer comprising about 45 wt. % of polymerized units of TFE, about 18 wt. % of polymerized units of HFP, and about 37 wt. % of polymerized units of VDF has a Tm of about 120° C. As yet another example, a fluoropolymer comprising about 76 wt. % of polymerized units of TFE, about 11 wt. % of polymerized units of HFP, and about 13 wt. % of polymerized units of VDF has a Tm of about 240° C. By Increasing the polymerized units of HFP/VDF, while reducing the polymerized units of TFE, the fluoropolymer becomes amorphous. An overview of crystalline and amorphous Fluoropolymers is described by Ullmann's Encyclopedia of Industrial Chemistry (7^{th} Edition, 2013 Wiley-VCH Verlag. 10. 1002/14356007.a11 393 pub 2) Chapter: Fluoropolymers, Organic.

In some embodiments, the crystalline fluoropolymers comprise little or no polymerized units of VDF. The amount of polymerized units of VDF is no greater than 5, 4, 3, 2, or 1 wt. % of the total crystalline fluoropolymer.

In some embodiments, the crystalline fluoropolymers comprises polymerized units of HFP. The amount of polymerized units of HFP can be at least 1, 2, 3, 4, 5 wt. % of the total crystalline fluoropolymer. In some embodiments, the amount of polymerized units of HFP is no greater than 15, 14, 13, 12, 11, or 10 wt. % of the total crystalline fluoropolymer.

In some embodiments, the fluoropolymers of the compositions described here comprise little or no polymerized units of vinylidene fluoride (VDF) (i.e. CH₂═CF₂) or VDF coupled to hexafluoropropylene (HFP). Polymerized units of VDF can undergo dehydrofluorination (i.e. an HF elimination reaction) as described in US2006/0147723. The reaction is limited by the number of polymerized VDF groups coupled to an HFP group contained in the fluoropolymer.

The crystalline fluoropolymer (e.g. particles) and amorphous fluoropolymer (e.g. particles) may be combined in a variety of ratios. For example, the coating composition contains about 5 to about 95 weight percent crystalline fluoropolymer (e.g. particles) and about 95 to about 5 weight percent amorphous fluoropolymer, based on the total weight percent of solids (i.e. excluding the solvent). In some embodiments, the coating composition contains about 10 to about 75 weight percent crystalline fluoropolymer (e.g. particles) and about 90 to about 25 weight amorphous fluoropolymer.

In some embodiments, the coating composition or fluoropolymer film contains at least 5, 10, or 15 weight percent ranging up to about 50, 55, 60, 65, 70, 75, or 80 weight percent crystalline fluoropolymer (e.g. particles) and about 20, 30, 40, or 50 to about 90 weight percent amorphous fluoropolymer. In some embodiments, the coating composition contains about 10 to about 30 weight percent crystalline fluoropolymer particles and about 90 to about 70 weight percent amorphous fluoropolymer.

In some embodiments, fluoropolymer composition comprises fluoropolymer particles have a particle size of greater than 1 micron. In typical embodiments, the fluoropolymer particles have an average particle size of no greater than 75, 70, 65, 60, 55, 50, 45, 35, 30, 30, 25, 20, 15, 10, or 5 microns. In some embodiments, the particle size of the fluoropolymer particles is less than the thickness of the fluoropolymer coating or fluoropolymer film layer. The average particle size is typically reported by the supplier. The particle size of the fluoropolymer particles of the fluoropolymer coating or fluoropolymer film layer can be determined by microscopy.

In some embodiments, the fluoropolymer particles comprise a mixture of particles including fluoropolymer particles having a particle size of greater than 1 micron and fluoropolymer particles having a particle size of 1 micron or less. In some embodiments, the submicron fluoropolymer particle size range may be about 50 to about 1000 nm, or about 50 to about 400 nm, or about 50 to about 200 nm.

The weight ratio of fluoropolymer particles having a particle size greater than 1 micron to fluoropolymer particles having a particle size of 1 micron or less typically ranges from 1:1 to 10:1.

In some embodiments, the weight ratio of larger to smaller fluoropolymer particles is at least 2:1, 3:1, 4:1, 5:1, 6:1, 7:1, 8:1 or 9:1.

The crystalline fluoropolymer (e.g. particles) are insoluble in fluorinated solvent. The crystalline fluoropolymer (e.g. particles) are also insoluble in non-fluorinated organic solvent such as methyl ethyl ketone (“MEK”), tetrahydrofuran (“THF”), ethyl acetate or N-methyl pyrrolidinone (“NMP”).

### Additives

Compositions containing curable fluoroelastomers may further contain additives as known in the art. Examples include acid acceptors. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

The fluoropolymer composition may further contain additives, such as stabilizers, surfactants, ultraviolet (“UV”) absorbers, antioxidants, plasticizers, lubricants, fillers, and processing aids typically utilized in fluoropolymer processing or compounding, provided they have adequate stability for the intended service conditions. A particular example of additives includes carbon particles, like carbon black, graphite, soot. Further additives include but are not limited to pigments, for example iron oxides, titanium dioxides. Other additives include but are not limited to clay, silicon dioxide, barium sulphate, silica, glass fibers, or other additives known and used in the art.

In some embodiments, the fluoropolymer composition comprises silica, glass fibers, thermally conductive particles, or a combination thereof. Any amount of silica and/or glass fibers and/or thermally conductive particles may be present. In some embodiments, the amount of silica and/or glass fibers is at least 0.05, 0.1, 0.2, 0.3 wt. % of the total solids of the composition. In some embodiments, the amount of silica and/or glass fibers is no greater than 5, 4, 3, 2, or 1 wt. % of the total solids of the composition. Small concentrations of silica can be utilized to thicken the coating composition. Further, small concentrations of glass fibers can be used to improve the strength of the fluoropolymer film. In other embodiments, the amount of glass fibers can be at least 5, 10, 15, 20, 25, 35, 40, 45 or 50 wt-% of the total solids of the composition. The amount of glass fibers is typically no greater than 55, 50, 45, 40, 35, 25, 20, 15, or 10 wt. %. In some embodiments, the glass fibers have a mean length of at least 100, 150, 200, 250, 300, 350, 400, 450, 500 microns. In some embodiments, the glass fibers have a mean length of at least 1, 2, or 3 mm and typically no greater than 5 or 10 mm. In some embodiments, the glass fibers have a mean diameter of at least 1, 2, 3, 4, or 5 microns and typically no greater than 10, 15, 30, or 25 microns. The glass fibers can have aspect ratio of at least 3:1, 5:1, 10:1, or 15:1.

In some embodiments, the fluoropolymer composition is free of (e.g. silica) inorganic oxide particles. In other embodiments, the fluoropolymer composition comprises (e.g. silica and/or thermally conductive) inorganic oxide particles. In some embodiments, the amount of (e.g. silica and/or thermally conductive) inorganic oxide particles is at least 5, 10, 15, 20, 25, 30, 35, 40, 45 or 50 wt. % of the total solids of the composition. In some embodiments, the amount of (e.g. silica and/or thermally conductive) inorganic oxide particles is no greater than 90, 85, 80, 75, 70, or 65 wt. % of the total solids of the composition. Various combinations of silica and thermally conductive particles can be utilized. In some embodiments, the total amount of (e.g. silica and thermally conductive) inorganic oxide particles or the amount of a specific type of silica particle (e.g. fused silica, fumed silica, glass bubbles, etc.) or thermally conductive particle (e.g. boron nitride, silicon carbide, aluminum oxide, aluminum trihydrate) is no greater than 60, 55, 50, 45, 40, 35, 30, 25, 20, 15, 10, or 5 wt. % of the total solids of the composition. Higher concentrations of (e.g. silica) inorganic oxide particles can be favorable to further reducing the dielectric properties. Thus, the compositions including (e.g. silica) inorganic oxide particles can have even lower dielectric properties than the crosslinked fluoropolymer alone.

In some embodiments, the (e.g. silica) inorganic oxide particles and/or glass fibers have a dielectric constant at 1 GHz of no greater than 7, 6.5, 6, 5.5, 5, 4.5, or 4. In some embodiments, the (e.g. silica) inorganic oxide particles and/or glass fibers have a dissipation factor at 1 GHz of no greater than 0.005, 004, 0.003, 0.002, or 0.0015.

In some embodiments, the composition comprises inorganic oxide particles or glass fibers that comprise predominantly silica. In some embodiments, the amount of silica is typically at least 50, 60, 70, 75, 80, 85, or 90 wt. % of the inorganic oxide particles or glass fibers, In some embodiments, the amount of silica is typically at least 90, 91, 92, 93, 94, 95, 96, 97, 98, 99, or greater (e.g. at least 99.5, 99.6, or 99.7) wt-% silica. Higher silica concentrations typically have lower dielectric constants. In some embodiments, (e.g. fused) silica particle can further comprise small concentration of other metals/meta oxides such as Al₂O₃, Fe₂O₅, TiO₂, K₂O, CaO, MgO and Na₂O. In some embodiments, the total amount of such metals/metal oxides (e.g. Al₂O₃, CaO and MgO) is independently no greater than 30, 25, 20, 15, or 10 wt. %. In some emboidments, the inorganic oxide particles or glass fibers may comprise B₂O₃ The amount of B₂O₃ can range up to 25 wt. % of the inorganic oxide particles or glass fibers. In other embodiments, (e.g. fumed) silica particle can further comprise small concentration of additional metals/metal oxides such as Cr, Cu, Li, Mg, Ni, P and Zr. In some embodiments, the total amount of such metals or metal oxides is no greater 5, 4, 3, 2, or 1 wt. %. In some embodiments, the silica may be described as quartz. The amount of non-silica metals or metal oxides can be determined by uses of inductively coupled plasma mass spectrometry. The (e.g. silica) inorganic oxides particles are typically dissolved in hydrofluroic acid and distilled as H₂SiF₆ at low temperatures.

In some embodiments, the inorganic particles may be characterized as an “agglomerate”, meaning a weak association between primary particles such as particles held together by charge or polarity. Agglomerate are typically physically broken down into smaller entities such as primary particles during preparation of the coating solution. In other embodiments, the inorganic particles may be characterized as an “aggregate”, meaning strongly bonded or fused particles, such as covalently bonded particles or thermally bonded particles prepared by processes such as sintering, electric arc, flame hydrolysis, or plasma. Aggregates are typically no broken down into smaller entities such as primary particles during preparation of the coating solution. “Primary particle size” refers to the mean diameter of a single (non-aggregate, non-agglomerate) particle. The (e.g. silica) particles may have various shapes such as spherical, ellipsoid, linear or branched. Fused and fumed silica aggregates are more commonly branched. The aggregate size is commonly at least 10× the primary particle size of discrete part.

In other embodiments, the (e.g. silica) particles may be characterized as glass bubbles. The glass bubble may be prepared from soda lime borosilicate glass. In this embodiment, the glass may contain about 70 percent silica (silicon dioxide), 15 percent soda (sodium oxide), and 9 percent lime (calcium oxide), with much smaller amounts of various other compounds.

In some embodiments, the inorganic oxide particles may be characterized as (e.g. silica) nanoparticles, having a mean or median particles size less than 1 micron. In some embodiments, the mean or median particle size of the (e.g. silica) inorganic oxide particles is at 500 or 750 nm. In other embodiments, the mean particle size of the (e.g. silica) inorganic oxide particles may be at least 1, 1.5, 2, 2.5, 3, 3.5, 4, 4.5, 5, 5.5, 6, 6.5, 7, 7.5, 8, 8.5, 9, 9.5 or 10 microns. In some embodiments, the mean particle size in no greater than 30, 25, 20, 15, or 10 microns. In some embodiments, the composition comprises little or no (e.g. colloidal silica) nanoparticles having a particle of 100 nanometers or less. The concentration of (e.g. colloidal silica) nanoparticles is typically less than (10, 9, 8, 7, 6, 5, 4, 3, 2, or 1 wt. %) The inorganic oxide (e.g. silica particle) may comprise a normal distribution of particle sizes having a single peak or a distribution of particles having two or more peaks.

In some embodiments, no greater than 1 wt. % of the (e.g. silica) inorganic oxide particles have a particle size greater than or equal to 3 or 4 microns. In some embodiments, no greater than 1 wt. % of the (e.g. silica) inorganic oxide particles have a particle size greater than or equal to 5 or 10 microns. In other embodiments, no greater than 5, 4, 3, 2, or 1 wt. % of the particles have a particle size greater than 45 microns. In some embodiments, no greater than 1 wt. % of the particles have a particle size ranging from 75 to 150 microns.

In some embodiments, the mean or median particle size refers to the “primary particle size” referring to the mean or median diameter of discrete a non-aggregated, non-agglomerated particles. For example, the particle size of colloidal silica or glass bubbles is typically the mean or median particle size of In preferred embodiments, the mean or median particle size refers to the mean or median diameter of the aggregates. The particle size of the inorganic particles can be measured using transmission electron microscopy. The particle size of the fluoropolymer coating solution can be measured using dynamic light scattering.

In some emboidments, the (e.g. silica) inorganic particles have a specific gravity ranging from 2.18 to 2.20 g/cc.

Aggregated particles, such as in the case of fumed and fused (e.g. silica) particles, can have a lower surface area than primary particles of the same size. In some embodiments, the (e.g. silica) particle have a BET surface area ranging from aobout 50 to 500 m²/g. In some embodiments, the BET surface area is less than 450, 400, 350, 300, 250, 200, 150, or 100 m²/g. In some embodiments, the inorganic nanoparticles may be characterized as colloidal silica. It is appreciated that unmodified colloidal silica nanoparticles commonly comprise hydroxyl or silanol functional groups on the nanoparticle surface and are typically characterized as hydrophilic.

In some emboidments, (e.g. silica aggregate) inorganic particles and especially colloidal silica nanoparticles are surface treated with a hydrophobic surface treatment. Common hydrophobic surface treatments include compounds such as alkoxylsilanes (e.g. octadecytriethoxysilane), silazane, or siloxanes. Various hydrophobic fumed silicas are commercially available from AEROSIL™, Evonik, and various other suppliers. Representative hydrophobic fumed silica include AEROSIL™ grades R 972, R 805, RX 300, and NX 90 S.

In some embodiments, (e.g. silica aggregate) inorganic particles are surface treated with a fluorinated alkoxysilane silane compound. Such compounds typically comprise a perfluoroalkyl or perfluoropolyether group. The perfluoroalkyl or perfluoropolyether group typically has no greater than 4, 5, 6, 7, 8 carbon atoms. The alkoxysilane group can be bonded to the alkoxy silane group with various divalent linking groups including alkylene, urethane, and —SO₂N(Me)-. Some representative fluorinated alkoxy silanes are described in U.S. Pat. No. 5,274,159 and WO2011/043973; incorporated herein by reference. Other fluorinated alkoxy silanes are commercially available.

In some embodiments, the fluoropolymer composition comprises thermally conductive particles. In some embodiments, the thermally conductive inorganic particles are preferably an electrically non-conductive material. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATH) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper. Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV. In this embodiment, the composition may optionally further comprise a small concentration of thermally conductive particles having an electronic band gap of less than 0 eV or greater than 20 eV.

In favored embodiments, the thermally conductive particles comprise a material having a bulk thermal conductivity >10 W/m*K. The thermal conductivity of some representative inorganic materials is set forth in the following table.

Thermally Conductive Materials

| | Thermal | Electronic | | |
|---|---|---|---|---|
| | Conductivity | Band Gap | | |
| Material | (W/m*K) | (eV) | Density | |
| α-Aluminum Oxide¹ | 30 | 5-9 | 3.95 | g/cc |
| Alumina Trihydrate² | 21 | | 2.42-2.45 | g/cc |
| Silicon Carbide (SiC)¹ | 120 | 2.4 | 3.21 | g/cc |
| Hexagonal Boron Nitride | 185-300 | 2.1 | 2.1 | g/cc |
| (BN)¹ | | | | |

In some embodiments, the thermally conductive particles comprise material(s) having a bulk thermal conductivity of at least 15 or 20 W/m*K. In other embodiments, the thermally conductive particles comprise material(s) having a bulk thermal conductivity of at least 25 or 30 W/m*K. In yet other embodiments, the thermally conductive particles comprise material(s) having a bulk thermal conductivity of at least 50, 75 or 100 W/m*K. In yet other embodiments, the thermally conductive particles comprise material(s) having a bulk thermal conductivity of at least 150 W/m*K. In typical embodiments, the thermally conductive particles comprise material(s) having a bulk thermal conductivity of no greater than about 350 or 300 W/m*K.

Thermally conductive particles are available in numerous shapes, e.g. spheres and acicular shapes that may be irregular or plate-like. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

Boron nitride particles are commercially available from 3M as “3M™ Boron Nitride Cooling Fillers”.

In some embodiments, the boron nitride particles has a bulk density of at least 0.05, 0.01, 0.15, 0.03 g/cm³ ranging up to about 0.60, 0.70, or 0.80 g/cm³. The surface area of the boron nitride particle can be <25, <20, <10, <5, or <3 m²/g. The surface area is typically at least 1 or 2 m²/g.

In some embodiments, the particle size, d(0.1), of the boron nitride (e.g. platelet) particles ranges from about 0.5 to 5 microns. In some embodiments, the particle size, d(0.9), of the boron nitride (e.g. platelet) particles is at least 5 ranging up to 20, 25, 30, 35, 40, 45, or 50 microns.

In some embodiments, the coating composition comprises an additive with hydroxy or alkoxy groups such as the previously described metal oxides (e.g. silica) and/or alkoxysilane silane compounds lacking an amine groups.

### Methods

The fluoropolymer compositions may be prepared by mixing the polymer, the curing agent(s), optional additives, and the fluorinated solvent. In some embodiments, the fluoropolymer is first dissolved in the fluorinated solvent and the other additives, including the curing agent(s) and electron donor compound are added thereafter.

The fluoropolymer and fluorinated curing agent can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives are distributed uniformly throughout the resulting fluorinated polymer “compound” or polymer sheets. The compound is then preferably comminuted, for example by cutting it into smaller pieces and is then dissolved in the solvent.

The fluoropolymer coating solution compositions provided herein are suitable for coating substrates. The fluoropolymer coating solution compositions may be formulated to have different viscosities depending on solvent and fluoropolymer content and the presence or absence of optional additives. The fluoropolymer coating solution compositions typically contain or are solutions of fluoropolymers and may be in the form of liquids or pastes. Preferably, the compositions are liquids and more preferably they are solutions containing one or more fluoropolymer as described herein dissolved in a solvent as described herein.

The fluoropolymer compositions provided herein are suitable for coating substrates and may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating and solvent casting.

Coated substrates and articles may be prepared by applying the fluoropolymer compositions to a substrate and removing the solvent. The curing may occur to, during, or after removing the solvent. The solvent may be reduced or completely removed, for example for evaporation, drying or by boiling it off After removal of the solvent the composition may be characterized as “dried”.

Methods of making a crosslinked fluoropolymer described herein comprise curing the fluoropolymer with (e.g. UV or e-beam) actinic irradiation. The fluoropolymer composition, substrate, or both are transmissive to the curing radiation. In some embodiments, a combination of UV curing and thermal (e.g. post) curing is utilized. The curing is carried out at an effective temperature and effective time to create a cured fluoroelastomer. Optimum conditions can be tested by examining the fluoroelastomer for its mechanical and physical properties. Curing may be carried out under pressure or without pressure in an oven. A post curing cycle at increased temperatures and or pressure may be applied to ensure the curing process is fully completed. The curing conditions depend on the curing system used.

In some embodiments, thermal curing of the fluoropolymer may optionally be carried out at lower temperatures. Post curing at lower temperatures is amenable for coating heat sensitive substrates. In some embodiments, the post curing occurs at a temperature ranging from 100, 110, 120, 130, 135 or 140° C. up to 170° C. for a period of 5-10 minutes to 24 hours. In some embodiments, the temperature is no greater than 169, 168, 167, 166, 165, 164, 163, 162, 161, or 160° C. In some embodiments, the temperature is no greater than 135, 130, 125, or 120° C. In favored embodiments, after curing the fluoropolymer is sufficiently crosslinked such that at least 80, 85, 90, 95 or 100 wt. % or greater cannot be dissolved (within 12 hours at 25° C.) in fluorinated solvent (e.g. 3-ethoxy perfluorinated 2-methyl hexane) at a weight ratio of 5 grams of fluoropolymer in 95% by weight of fluorinated solvent.

The compositions may be used for impregnating substrates, printing on substrates (for example screen printing), or coating substrates, for example but not limited to spray coating, painting dip coating, roller coating, bar coating, solvent casting, paste coating. The substrate may be organic, inorganic, or a combination thereof. Suitable substrates may include any solid surface and may include substrate selected from glass, plastics (e.g. polycarbonate), composites, metals (stainless steel, aluminum, carbon steel), metal alloys, wood, paper among others. The coating may be colored in case the compositions contains pigments, for example titanium dioxides or black fillers like graphite or soot, or it may be colorless in case pigments or black fillers are absent.

Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK.

Articles containing a coating from the compositions provided herein include but are not limited to impregnated textiles, for example protective clothing. Another example of an impregnated textile is a glass scrim impregnated with the (e.g. silica containing) fluoropolymer composition described herein. Textiles may include woven or non-woven fabrics. Other articles include articles exposed to corrosive environments, for example seals and components of seals and valves used in chemical processing, for example but not limited to components or linings of chemical reactors, molds, chemical processing equipment for example for etching, or valves, pumps and tubing, in particular for corrosive substances or hydrocarbon fuels or solvents; combustion engines, electrodes, fuel transportation, containers for acids and bases and transportation systems for acids and bases, electrical cells, fuel cells, electrolysis cells and articles used in or for etching.

An advantage of the coating compositions described herein is that the coating compositions can be used to prepare coatings or fluoropolymer sheets of high or low thickness. In some embodiments, the dried and cured fluoropolymer has a thickness of 0.1 microns to 1 or 2 mils. In some embodiments, the dried and cured fluoropolymer thickness is at least 0.2, 0.3, 0.4, 0.5, or 0.6 microns. In some embodiments, the dried and cured fluoropolymer thickness is at least 1, 2, 3, 4, 5, or 6 microns.

In typical embodiments, the dried and cured (i.e. crosslinked) composition has a low dielectric constant (Dk), typically less than 2.75, 2.70, 2.65, 2.60, 2.55, 2.50, 2.45, 2.40, 2.35, 2.30, 2.25, 2.20, 2.15, 2.20, 2.15, 2.10, 2.05, 2.00, 1.95, 1.90. In some embodiments, the dielectric constant is at least 1.90, 1.95, or 2.00. The dried and cured (i.e. crosslinked) composition has a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023, 0.00024, 0.00025.

The dried and cured coating can exhibit good adhesion to metals, such as copper. For example, in some embodiments, the T-peel to copper foil is at least 0.1, 0.2, 0.3, 0.4, 0.5 or 0.6 N/mm ranging up to at least 1 N/mm (i.e. 10 N/cm), 1.5 N/mm 2 N/mm or 2.5 N/mm or greater as determined by the test method described in the examples.

In some emboidments, the dried and cured coating has good hydrophobic and oleophobic properties according to the Black Permanent Marker Resistance Test described in previously cited PCT Application No. PCT/US2019/036460, i.e. the marker fluid beads and is easy to remove with a paper towel or cloth.

In some embodiments, the dried and cured coating has good hydrophobic and oleiphobic properties, as determined by Contact Angle Measurements (as determined according to the test method described in the examples). In some embodiments, the static, advancing and/or receding contact angle with water can be at least 100, 105, 110, 115, 120, 125 and typically no greater than 130 degrees. In some embodiments, the advancing and/or receding contact angle with hexadecane can be at least 60, 65, 70, or 75 degrees.

In some embodiments, the dried and cured coating (e.g. film) exhibits low water absorption e.g. less than 0.5, 0.4, 0.3, 0.2, or 0.1 as determined by the Moisture Uptake test method described in the examples.

In some embodiments, the composition exhibits a low coefficient of thermal expansion e.g. less than 150, 100, 50, 40, 30, 20 or 10 as determined by the test method described in the examples. For some insulation layer uses the coefficient of thermal expansion is less critical and may range up to 175, 200 or 225.

### Electronic Telecommunication Articles

The fluoropolymer compositions described herein are suitable for use in electronic telecommunication articles as described in previously cited WO2021/091864. As used herein, electronic refers to devices using the electromagnetic spectrum (e.g. electrons, photons); whereas telecommunication is the transmission of signs, signals, messages, words, writings, images and sounds or information of any nature by wire, radio, optical or other electromagnetic systems.

Perfluoropolymers can have substantially lower dielectric constants and dielectric loss properties than polyimides which is particularly important for fifth generation cellular network technology (“5G”) articles. For example, crosslinked fluoropolymer compositions described herein can have a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95. In some embodiments, the dielectric constant is at least 2.02, 2.03, 2.04, 2.05. Further, the crosslinked fluoropolymer compositions described herein can have a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023, 0.00024, 0.00025. The dielectric properties (e.g. constant and loss) can be determined according to the test method described in the examples. As the number of non-fluorine atoms decreases (e.g. number of carbon-hydrogen and/or carbon-oxygen bonds increases) the dielectric constant and dielectric loss also typically increases.

In one embodiment, the electronic telecommunication article is an integrated circuit or in other words a silicon chip or microchip, i.e. a microscopic electronic circuit array formed by the fabrication of various electrical and electronic components (resistors, capacitors, transistors, and so on) on a semiconductor material (silicon) wafer. Various integrated circuit designs have been described in the literature.

In some embodiments, particularly when it is desirable to apply a thin fluoropolymer film to the substrate, the method comprises applying a coating solution (e.g. spin coating) to a substrate. The coating solution comprises a fluorinated solvent and a fluoropolymer. The method typically comprises removing the fluorinated solvent (e.g. by evaporation). In this embodiment, the substrate or (e.g. SiO₂) coated surface thereof that comes in contact with the solvent is substantially insoluble in the fluorinated solvent of the coating solution. Further, the method typically comprises recycling, or in other words reusing, the fluorinated solvent of the coating solution.

In some embodiments, the fluoropolymer may be characterized are a patterned fluoropolymer layer. A patterned fluoropolymer lay may be formed by any suitable additive or subtractive method known in the art.

The patterned fluoropolymer layer can be used to fabricate other layers such as a circuit of patterned electrode materials. Suitable electrode materials and deposition methods are known in the art. Such electrode materials include, for example, inorganic or organic materials, or composites of the two. Exemplary electrode materials include polyaniline, polypyrrole, poly(3,4-ethylenedioxythiophene) (PEDOT) or doped conjugated polymers, further dispersions or pastes of graphite or particles of metal such as Au, Ag, Cu, Al, Ni or their mixtures as well as sputter-coated or evaporated metals such as Cu, Cr, Pt/Pd, Ag, Au, Mg, Ca, Li or mixtures or metal oxides such as indium tin oxide (ITO), F-doped ITO, GZO (gallium doped zinc oxide), or AZO (aluminium doped zinc oxide). Organometallic precursors may also be used and deposited from a liquid phase.

In another embodiment, the fluoropolymer (e.g. photoresist) layer can be disposed upon a metal (e.g. copper) substrate in the manufacture of a printed circuit board (PCB). A printed circuit board, or PCB, is used to mechanically support and electrically connect electronic components using conductive pathways, tracks or signal traces etched from (e.g. copper) metal sheets laminated onto a non-conductive substrate. Such boards are typically made from an insulating material such as glass fiber reinforced (fiberglass) epoxy resin or paper reinforced phenolic resin. The pathways for electricity are typically made from a negative photoresist, as previously described. Thus, in this embodiment, the crosslinked fluoropolymer is disposed on the surface of the (e.g. copper) metal substrate. Portions of uncrosslinked fluoropolymer are removed to form the conductive (e.g. copper) pathways. Crosslinked fluoropolymer (e.g. photoresist) remain present, disposed between the conductive (e.g. copper) pathways of the printed circuit board. Solder is used to mount components on the surface of these boards. In some embodiments, the printed circuit board further comprises integrated circuits. Printed circuit board assemblies have an application in almost every electronic article including computers, computer printers, televisions, and cell phones.

In another embodiment, the crosslinked fluoropolymer film described herein can be utilized as an insulating layer, passivation layer, and/or protective layer in the manufacture of integrated circuits.

In one embodiment, a thin fluoropolymer film (e.g. typically having a thickness less than 50, 40, or 30 mn) can be disposed on a passivation layer (e.g. SiO₂) disposed on an electrode patterned silicon chip.

In another embodiment, a thicker fluoropolymer film (e.g. typically having a thickness of at least 100, 200, 300, 400, 500 nm) can be disposed on an electrode patterned silicon chip. In this embodiment, the fluoropolymer layer may function as both a passivation layer and an insulating layer. Passivation is the use of a thin coating to provide electrical stability by isolating the transistor surface from electrical and chemical conditions of the environment.

In another embodiment, the crosslinked fluoropolymer film described herein can be utilized as a substrate for antennas. The antenna of the transmitter emits (e.g. high frequency) energy into space while the antenna of the receiver catches this and converts it into electricity.

The patterned electrodes of an antenna can also be formed from photolithography. Screen printing, flexography, and ink jet printing can also be utilized to form the electrode pattern as known in the art. Various antenna designs for (e.g. mobile) computing devices (smart phone, tablet, laptop, desktop) have been described in the literature.

The low dielectric fluoropolymer films and coatings described herein can also be utilized as insulating and protective layers of transmitter antennas of cell towers and other (e.g. outdoor) as well as indoor structures.

In another embodiment, the low dielectric fluoropolymer compositions described herein may also be utilized in fiber optic cable. The low dielectric fluoropolymer compositions described herein can be used as the cladding, coating, outer jacket, or combination thereof.

In other embodiments, the low dielectric fluoropolymer films and coatings described herein can also be utilized for flexible cables and as an insulating film on magnet wire. For example, in a laptop computer, the cable that connects the main logic board to the display (which must flex every time the laptop is opened or closed) may be a low dielectric fluoropolymer composition as described herein with copper conductors.

The fluoropolymer films and coatings are typically not a sealing component of equipment used in wafer and chip production.

One of ordinary skill in the art appreciates that the low dielectric fluoropolymer compositions described herein can be utilized in various electronic telecommunication articles, particularly in place of polyimide, and such utility is not limited to the specific articles described herein.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂ClC— or FHClC— are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HC—O—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHClC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

The following examples are provided to further illustrate the present disclosure without any intention to limit the disclosure to the specific examples and embodiments provided.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| PFE131 | Perfluoroelastomer latex or coagulated gum | 3M Dyneon, St. |
| | comprising a copolymer of 65.8 mol % TFE, 33 | Paul, MN |
| | mol PMVE, 1.2 mol % of a nitrile vinylether (U.S. | |
| | Pat. No. 7,019,083); As a latex, PFE = 30.5 wt. % in | |
| | water with surfactant | |
| PFA6900 | Latex (50 w % solids) comprising a polymer of TFE | 3M Dyneon |
| | (97 w %), PMVE (CF₂═CF—O—CF₃, 2 w %) and | |
| | CF₂═CF—O—C₃F₇ (1 w %), melting point 307° C., | |
| | MFI (372° C./5 kg) 2 g/10 min; 200 nanometers; | |
| | under the trade designation “3M DYNEON | |
| | Fluoroplastic PFA 6900GZ” | |
| TF5060 | PTFE dispersion in ~59 wt %, 210 um; under the | 3M Dyneon |
| | trade designation “3M DYNEON Fluoroplastic TF | |
| | 5060GZ” | |
| FS550 | Fused silica (3.5-5.2 micrometers), obtained under | 3M Company, St. |
| | the trade designation “3M FUSED SILICA 550” | Paul, MN |
| QZ-1 | Quartz fiber in ~1 millimeter length and ~8 | Shenjiu, Henan |
| | micrometer diameter | Province, China |
| HFE-7300 | 3-methoxy perfluorinated 4-methyl petane obtained | 3M Company |
| | under the trade designation “NOVEC 7300” | |
| NHDiSiM | Bis(3-trimethoxysilylpropyl)amine - | Gelest, Morrisville, |
| | NH[C₃H₆Si(OMe)₃]₂ | PA |
| NHDiSiE | Bis(3-triethoxysilylpropyl)amine - | Gelest |
| | NH[C₃H₆Si(OEt)₃]₂ | |
| CH₃OH | Methanol grade “OMNISOLV” HR-GC | EMD Millipore, |
| | | Burlington, MA |
| CF₃CH₂OH | 2,2,2-trifluoorethanol, boiling point = 74° C. | Alfa Aesar, |
| | | Haverhill, MA |
| CF₃CF₂CH₂OH | 2,2,3,3,3-pentafluoropropanol, boiling point = | Sigma-Aldrich, St. |
| | 80° C./748 mm Hg | Louis, MO |
| CF₃OC₂F₄CH₂OH | Fluorinated alcohol, boiling point = 105-106° C. | 3M Company |
| C₄F₉OCF(CF₃)CH₂OH | Fluorinated alcohol, boiling point = 134~136° C. | 3M Company |

### Test Methods

### Viscosity Test Method

All solution viscosity was measured by standard procedures using a Brookfield Viscometer at room temperature and results are reported in cP (centipoise).

### Dk/Df Test Method at 25 GHz

All split-post dielectric resonator measurements were performed in accordance with the standard IEC 61189-2-721 near a frequency of 25 GHz. Each thin material or film was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. This 25 GHz resonator operates with the TE_{old} mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 25 GHz Split Post Resonator measurement system was combined with Keysight VNA (Vector Network Analyzer Model PNA 8364C 10 MHz-50 GHz). Computations were performed with the commercial analysis Split Post Resonator Software of QWED to provide a powerful measurement tool for the determination of complex electric permittivity of each specimen at 25 GHz.

### EXAMPLES

### Coating Solutions and Test Film Preparation

Coating solutions were formulated by adding fillers, then crosslinkers (10% solution in HFE-7300) to PFE solution in HFE-7300 in designed wt. % based on the weight of PFE, and fully mixed for approximately 2 minutes via vortex at 2500 revolutions per minute (RPM).

Test films were prepared by coating the coating solutions on a release liner at 10-20 micrometer thickness, then cured in an 180° C. oven for 2 hours.

### Formulation Stability Study in the Presence of Crosslinkers

Representative viscosity of PFE131 solution (5 wt. % in HFE-7300) with 4 wt. % NH[C₃H₆Si(OEt)₃]₂ crosslinker was measured over time (in hours (hr)) either in rolling (R) or standing (S) conditions. Results are summarized in Table 2.

TABLE 2

| | Fluoropolymer | Crosslinker, | | | | | | | |
|---|---|---|---|---|---|---|---|---|---|
| | (5 wt. % | wt. % based on | Viscosity, cP | | | | | | |
| | solution in | fluoropolymer | 0 | 0.1 | 0.5 | 1 | 3.5 | 24 | 48 |
| EX. | HFE-7300) | solids | hr | hr | hr | hr | hr | hr | hr |
| Control | PFE131 | 4% (R) - | 238 | 296 | 343 | 353 | 420 | 5776 | Gelled |
| EX. 1 | | NHDiSiE | | | | | | | |
| Control | PFE131 | 4% (S) - | 238 | 250 | 268 | 278 | 352 | 3768 | Gelled |
| EX. 2 | | NHDiSiE | | | | | | | |

### Rf—OH Effect on Formulation Stability

In searching for stabilizer, different approaches were focused on reactivity modification of the amine group and the silane group form the amino-silane crosslinker agent. One of the approaches was the addition of alcohol targeting to slow down the hydrolysis of silane group for enhanced shelf-life stability.

Stabilizer compatibility with HFE-7300

It has been found that the addition of hydrocarbon alcohol, such as methanol, to the nitrile functionalized perfluoroelastomer (CN—PFE) solution in HFE results in the precipitation of CN—PFE from HFE solvent, and fluorinated alcohols have better compatibility and solubility in CN—PFE/HFE solution as shown in Table 3. The amount of alcohol wt. % is related to the total weight of the Fluoropolymer solution.

TABLE 3

| | Fluoropolymer (5 | | |
|---|---|---|---|
| | wt. % solution in | | |
| | HFE-7300), wt. % | Stabilizer, wt. % based | |
| | based on total | on total weight of | Stability (solution under |
| EX. | weight of solution | solution | continuous rolling) |
| Control | 95% PFE131 | 5% CH₃OH | Some PFE precipitation |
| Example 3 | | | in <3 hr |
| EX-4 | 95% PFE131 | 5% CF₃CH₂OH | Slightly hazy, OK at 1 week |
| EX-5 | 95% PFE131 | 5% CF₃CF₂CH₂OH | Clear & stable at 1 week |
| EX-6 | 95% PFE131 | 5% CF₃OC₂F₄CH₂OH | Clear & Stable at 1 week |

### Stabilizer Effect on Coating Formulation Shelf-Life Stability

Further study of the alcohol in CN—PFE with amino-silane crosslinker, representative formulation stability results were recorded and summarized in Table 4.

TABLE 4

| | Fluoropolymer (5 | | |
|---|---|---|---|
| | wt. % solution in | Stabilizer (wt. % based on total | |
| | HFE-7300), wt. % | weight of solution)/ | Stability (solution |
| | based on total | Crosslinker (wt. % based on | under continuous |
| EX. | weight of solution | fluoropolymer solids) | rolling) |
| Control | 95% PFE131 | 5% NHDiSiM (crosslinker) | ~2 days (hazy) |
| Example 7 | | | |
| Control | 95% PFE131 | 5% NHDiSiE (crosslinker) | ~2 days (white) |
| Example 8 | | | |
| Control | 95% PFE131 | 5% CH₃OH/5% NHDiSiE | PFE precipitated |
| Example 9 | | | in <3 hr |
| EX-10 | 99.75% PFE131 | 0.25% CF₃OC₂F₄CH₂OH/5% | <4 days (Gelled) |
| | | NHDiSiM | |
| EX-11 | 95% PFE131 | 5% CF₃OC₂F₄CH₂OH/4% | >40 days, High |
| | | NHDiSiE | Viscosity |
| EX-12 | 95% PFE131 | 5% CF₃CH₂OH/5% | Slightly hazy, >20 |
| | | NHDiSiM | days |
| EX-13 | 95% PFE131 | 5% CF₃CF₂CH₂OH/5% | Clear; >40 days |
| | | NHDiSiM | |
| EX-14 | 95% PFE131 | 5% C₄F₉OCF(CF₃)CH₂OH/ | Hazy; 4 days - |
| (branched | | 5% NHDiSiM | White/High |
| alcohol) | | | Viscosity; |
| | | | 5 days - gelled |

### Rf—OH Stabilizer Effect on Dk/Df

Following the demonstrated shelf-life stability enhancement by addition of fluorinated alcohol stabilizer, the effect of the stabilizer on potential Dk and Df was examined and the results were summarized in Table 5.

TABLE 5

| | | | | C₂F₅CH₂OH, | | | |
|---|---|---|---|---|---|---|---|
| | | Filler(s), wt. % | NHDiSiE, wt. % | wt. % based | | | |
| | | based on | based on | on total | | | |
| | Fluoropolymer, | fluoropolymer | fluoropolymer | weight of | Curing | | |
| EX. | wt. % | solids | solids | solution | Conditions | Dk | Df |
| EX-15 | 96% PFE131 (5 | / | 4% | / | 180° C./2 hr | 2.12 | 0.0022 |
| | wt. % solution in | | | | | | |
| | HFE-7300) | | | | | | |
| EX-16 | 95% PFE131 (5% | / | 4% | 5% | 180° C./2 hr | 2.08 | 0.0023 |
| | solution) | | | | | | |
| EX-17 | 95% | / | 5% | / | 180° C./2 hr | 2.18 | 0.0020 |
| | PFE131/PFA6900 | | | | | | |
| | (7/3) (10 wt. % | | | | | | |
| | solution in HFE- | | | | | | |
| | 7300) | | | | | | |
| EX-18 | 95% | / | 5% | / | 180° C./2 hr | 2.11 | 0.0019 |
| | PFE131/PFA6900 | | | | | | |
| | (7/3) (10 wt. % | | | | | | |
| | solution in HFE- | | | | | | |
| | 7300) | | | | | | |
| EX-19 | 95% | / | 5% | 5% | 180° C./2 hr | 2.14 | 0.0021 |
| | PFE131/PFA6900 | | | | | | |
| | (7/3) (10 wt. % | | | | | | |
| | solution in HFE- | | | | | | |
| | 7300) | | | | | | |
| EX-20 | 95% | / | 5% | 5% | 180° C./2 hr | 2.08 | 0.0023 |
| | PFE131/PFA6900 | | | | | | |
| | (7/3) (10 wt. % | | | | | | |
| | solution in HFE- | | | | | | |
| | 7300) | | | | | | |
| EX-21 | PFE131/TF5060 | 29% FS550 | 5% | / | 120° C./2 hr | 2.03 | 0.0033 |
| | (7/3) (10 wt. % | 3% QZ-1 | | | | | |
| | solution in HFE- | | | | | | |
| | 7300) | | | | | | |
| EX-22 | PFE131/TF5060 | 29% FS550 | 5% | / | 180° C./2 hr | 2.22 | 0.0019 |
| | (7/3) (10 wt. % | 3% QZ-1 | | | | | |
| | solution in HFE- | | | | | | |
| | 7300) | | | | | | |
| EX-23 | 95% | 29% FS550 | 5% | 5% | 120° C./2 hr | 2.13 | 0.0031 |
| | PFE131/TF5060 | 3% QZ-1 | | | | | |
| | (7/3) (10 wt. % | | | | | | |
| | solution in HFE- | | | | | | |
| | 7300) | | | | | | |
| EX-24 | 95% | 29% FS550 | 5% | 5% | 180° C./2 hr | 2.20 | 0.0020 |
| | PFE131/TF5060 | 3% QZ-1 | | | | | |
| | (7/3) (10 wt. % | | | | | | |
| | solution in HFE- | | | | | | |
| | 7300) | | | | | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A coating composition comprising
a fluoropolymer;
a fluorinated solvent; and
a fluorinated alcohol.

2. The coating composition of claim 1 wherein the fluoropolymer is soluble in the fluorinated solvent.

3. The coating composition of claim 1 wherein the fluoropolymer is insoluble in the fluorinated alcohol.

4. The coating composition of claim 1 wherein the fluorinated alcohol is present in an amount no greater than 10 wt. % of the sum of the fluorinated solvent and fluorinated alcohol.

5. The coating composition of claim 1 wherein the fluorinated alcohol comprises a single hydroxy group or more than one hydroxy groups.

6. The coating composition of claim 1 wherein the fluorinated alcohol comprises a straight-chain (per)fluoroalkyl or (per)fluoroalkylene group.

7. The coating composition of claim 1 wherein the fluorinated alcohol has a boiling point no greater than 160, 150, 140, 130, or 120° C.

8. The coating composition of claim 1 wherein the fluorinated solvent is a partially fluorinated ether.

9-12. (canceled)

13. The coating composition of claim 1 wherein the coating composition further comprises a compound with one or more alkoxy silane groups.

14. The coating composition of claim 1 wherein the coating composition further comprises a compound with one or more amine groups.

15. The coating composition of claim 1 wherein the compound is a crosslinking compound comprising at least two amine groups, at least two alkoxy silane groups, or at least one amine and at least one alkoxy silane groups.

16. The coating composition of claim 1 wherein the compound is non-fluorinated.

17. The coating composition of claim 1 wherein the coating composition further comprises an additive with hydroxy or alkoxy groups.

18. The coating composition of claim 17 wherein the additive comprises a metal oxide or an alkoxy silane compound lacking an amine group.

19. The coating composition of claim 18 wherein the metal oxide comprises silica including fumed silica, fused silica, glass bubbles, or a combination thereof.

20. (canceled)

21. The electronic telecommunication article of claim 1 wherein the fluoropolymer further comprises nitrile or halogen cure sites.

22. The coating composition of claim 1 wherein the fluoropolymer comprises at least 80, 85, or 90% by weight of polymerized units of perfluorinated monomers.

23. The coating composition of claim 1 wherein the perfluorinated monomers are selected from tetrafluoroethene (TFE) and one or more unsaturated perfluorinated alkyl ethers.

24-27. (canceled)

28. The coating composition of claim 1 wherein upon removal of the fluorinated solvent and fluorinated alcohol the composition has
i) a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95;
ii) a dielectric loss of less than 0.01, 0.009, 0.008, 0.007, 0.006, 0.005, 0.004, 0.003, 0.002, 0.001, 0.0009, 0.0008, 0.0007, or 0.0006;
or a combination thereof.

29-35. (canceled)

36. An electronic communications article comprising a fluoropolymer layer comprising the coating composition of claim 1.

37-38. (canceled)
